(19) United States
(12) Patent Application Publication
(10) Pub. No.: US 2025/0220741 A1
(43) Pub. Date: Jul. 3, 2025

(54) Access Network Query Protocol (ANQP) Based Assistance for Peer-to-Peer (P2P) Communications

(71) Applicant: Cisco Technology, Inc., San Jose, CA (US)

(72) Inventors: Robert Barton, VANCOUVER (CA); Jerome Henry, Pittsboro, NC (US); Vinay Saini, BANGALORE (IN)

(21) Appl. No.: 18/929,443

(22) Filed: Oct. 28, 2024

(30) Foreign Application Priority Data
Dec. 27, 2023 (IN) IN202341089063

(51) Int. Cl. H04W 76/14; H04L 67/104; H04W 8/00; H04W 76/11

(52) U.S. Cl. CPC H04W 76/14; H04L 67/104; H04W 8/005; H04W 76/11

(57) ABSTRACT

Existing peer-to-peer (P2P) communication strategies in a wireless network often lead to network inefficiency and a poor user experience. To address this, devices, systems, methods, and processes for facilitating Access Network Query Protocol (ANQP) based assistance for P2P communications are described herein. A client device may be configured with a P2P exchange logic that transmits a P2P service request. The P2P service request is transmitted via ANQP request message. The client device may receive a list of one or more basic service set identifiers (BSSIDs) based on the transmitted P2P service request. The client device may select a BSSID based on the list of one or more BSSIDs and transmit a P2P scheduling request to an AP associated with the selected BSSID. The AP associated with the selected BSSID in turn responds with a P2P scheduling grant in order to activate P2P communication.

The present disclosure relates to communication networks. More particularly, the present disclosure relates to access network query protocol (ANQP)-based assistance for peer-to-peer (P2P) communications.

This application claims the benefit of Indian Provisional Patent Application No. IN202341089063, filed Dec. 27, 2023, which is incorporated by reference herein in its entirety.

### BACKGROUND

With the rapid growth of wearables and associated devices like smartwatches (e.g., iWatch and fitness trackers), there is an increasing demand for Wireless Fidelity (Wi-Fi) client devices to establish peer-to-peer (P2P) communication with other Wi-Fi devices. As P2P communications enable direct data exchange between devices without relying on a central server, they can be resilient to single points of failure. P2P communications can also enable more privacy and control for users.

The traditional Datagram Transport Layer Security (DTLS) mode, commonly used for secure communications, offers limited options for P2P communication to stations (STAs) and the access points (APs). In the DTLS mode, an STA has a single AP to query for establishing a P2P link. The AP can either accept or decline the request. If the AP declines, the STA has no alternative but to ignore the AP and abandon the P2P communication attempt, which can be disruptive. On the other hand, if the AP accepts, the STA can establish a P2P link, but the STA then takes control of the channel, potentially causing channel contention and degrading the performance of AP-based basic service sets (BSSs).

Existing methods for establishing a P2P communication has several disadvantages, particularly in increasingly dense Wi-Fi environments. Firstly, the binary decision-making process (e.g., accept or decline) does not provide flexibility or alternative paths for the STA to establish P2P communication, leading to disruptions in connectivity. This rigid approach can cause network inefficiency and a poor user experience. Secondly, when an AP accepts a P2P request, the STA's control of the channel can interfere with regular network operations and degrade the quality of service for other devices connected to the same AP. Thus, P2P communications are not effectively managed by the network infrastructure impacting functioning of AP-based BSSs.

### SUMMARY OF THE DISCLOSURE

Systems and methods for facilitating access network query protocol (ANQP) based assistance for peer-to-peer (P2P) communications in accordance with embodiments of the disclosure are described herein. In many embodiments, a client device includes a processor, a network interface controller configured to provide access to a network, and a memory communicatively coupled to the processor. The memory comprises a P2P exchange logic that is configured to transmit a P2P service request, receive a list of one or more basic service set identifiers (BSSIDs) based on the transmitted P2P service request, select a BSSID based on the list of one or more BSSIDs, and transmit a P2P scheduling request to an access point (AP) associated with the selected BSSID.

In a variety of embodiments, the P2P service request is transmitted via an ANQP request message.

In a number of embodiments, the P2P service request is transmitted to an advertisement server (AS) via a first AP, and the list of one or more BSSIDs is received from the AS via the first AP.

In several embodiments, the P2P exchange logic is further configured to receive an indication of support for generic advertisement service (GAS) or ANQP from the first AP, and the P2P service request is transmitted based on the indication of the support for GAS or ANQP.

In further embodiments, the selected BSSID is associated with a lowest signal strength at the client device.

In numerous embodiments, the P2P exchange logic is further configured to opt out of associating with the AP associated with the selected BSSID.

In more embodiments, the client device supports a multi-link operation (MLO), and the P2P exchange logic is further configured to associate with a first AP different from the AP associated with the selected BSSID.

In various embodiments, the selected BSSID is on the list of one or more BSSIDs.

In yet more embodiments, the client device includes a single radio.

In still more embodiments, the P2P exchange logic is further configured to associate with the AP associated with the selected BSSID.

In still yet more embodiments, the P2P exchange logic is further configured to associate with a first AP different from the AP associated with the selected BSSID, and the P2P scheduling request is transmitted to the AP associated with the selected BSSID via the first AP and a link between the first AP and the AP associated with the selected BSSID.

In still further embodiments, the list of one or more BSSIDs further comprises at least one of an indication of a P2P pair count or quality of service (QOS) basic service set (QBSS) load data associated with at least one of the one or more BSSIDs.

In many further embodiments, the P2P exchange logic is further configured to receive a P2P scheduling grant from the AP and perform a P2P exchange based on the received P2P scheduling grant.

In yet further embodiments, the P2P scheduling grant is received in response to transmitting the P2P scheduling request.

In still yet further embodiments, a network device comprises a processor, a network interface controller configured to provide access to a network, and a memory communicatively coupled to the processor. The memory comprises a P2P exchange logic that is configured to receive a P2P service request, select one or more BSSIDs from a pool of BSSIDs associated with a neighbor AP list based on the received P2P service request and at least one criterion, and transmit a list of the selected one or more BSSIDs.

In several more embodiments, the P2P service request is received from a client device via an AP, and the list of the selected one or more BSSIDs is transmitted to the client device via the AP.

In several additional embodiments, based on the at least one criterion, each of the selected one or more BSSIDs is associated with a P2P pair count that is less than a first threshold or a channel utilization measure that is less than a second threshold.

In numerous additional embodiments, the P2P exchange logic is further configured to receive, from each AP of one or more APs on the neighbor AP list, an indication of at least one of a P2P pair count associated with an AP or QBSS load data associated with the AP and store the indication of at least one of the P2P pair count or the QBSS load data.

In some more embodiments, the network device corresponds to an advertisement server (AS) or a wireless local area network (LAN) controller (WLC).

In one or more embodiments, a network device comprises a processor, a network interface controller configured to provide access to a network, a memory communicatively coupled to the processor. The memory comprises a P2P exchange logic that is configured to transmit an indication of at least one of a P2P pair count associated with the network device or QBSS load data associated with the network device to an advertisement server, forward a P2P service request, and transmit a list of one or more BSSIDs as a response for the P2P service request.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a conceptual network diagram of various environments that implement a peer-to-peer (P2P) exchange logic in accordance with various embodiments of the disclosure;

FIG. 3 is a schematic block diagram of an example network in accordance with various embodiments of the disclosure;

FIG. 4 is a conceptual diagram of an example table in accordance with various embodiments of the disclosure.

FIG. 5 is a flowchart depicting a process for ANQP-based assistance for P2P exchange scheduling in accordance with various embodiments of the disclosure;

FIG. 6 is a flowchart showing a process for ANQP-based assistance for P2P exchange scheduling in accordance with various embodiments of the disclosure;

FIG. 7 is a flowchart showing a process for P2P exchange scheduling with ANQP-based assistance in accordance with various embodiments of the disclosure;

FIG. 8 is a flowchart showing a process for P2P exchange scheduling with ANQP-based assistance in accordance with various embodiments of the disclosure;

FIG. 9 is a flowchart showing a process for ANQP-based assistance for P2P exchange scheduling in accordance with various embodiments of the disclosure; and

FIG. 10 is a conceptual block diagram of a device suitable for configuration with a P2P exchange logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein to facilitate access network query protocol (ANQP) based assistance for peer-to-peer (P2P) communications. A P2P network architecture may use wireless communication methods for various network devices such as stations (STA), access points (AP), wireless local area network (LAN) controller (WLC), servers, or the like. In the P2P network architecture involving STAs (e.g., client devices such as smartwatches, smart cameras, mobile devices, laptops, or the like), and APs, the communication framework is designed to allow STAs to communicate directly with each other without always relying on a central AP. The P2P network architecture may be particularly useful in scenarios where STAs need to exchange data directly, such as file transfers, gaming, or connecting smart home devices. Traditionally, the P2P communication has been managed using Datagram Transport Layer Security (DTLS), a protocol that allows the STA to communicate with the AP to request permission for P2P communication. However, the AP has only two choices: accept or decline the STA's request. If the AP declines, the STA has no choice but to abandon its attempt to establish a P2P connection, which can be disruptive. If accepted, the STA gains control of the channel, which can impact the AP's ability to manage its own Basic Service Set (BSS) effectively.

Despite the various improvements, existing technologies handling P2P communication has notable limitations, especially in environments with a high density of network devices. Firstly, the lack of flexibility in the STA-AP negotiation process results in a poor user experience when P2P requests are declined, leaving the STA with no viable options and potentially causing connectivity issues. Secondly, when P2P communication is permitted, the control of the STA over the channel can lead to interference with the primary operations of the AP, impacting network performance and degrading service quality for other devices on the same network. As Wi-Fi standards evolve, particularly with the advent of Wi-Fi 8, there is a growing need for more intelligent, infrastructure-driven management of P2P communications to reduce their impact on AP-based BSSs and ensure a more balanced and efficient use of network resources.

Therefore, the present disclosure provides one or more STAs, a plurality of APs, an advertisement server (AS) communicatively coupled to the plurality of APs, and a network architecture facilitating ANQP-based assistance for P2P communications for enabling P2P exchange. The term “P2P exchange” may refer to direct communication between two STAs in a network, allowing them to share data without the need to route traffic through a primary AP. The P2P exchange is required when STAs need to transfer large amounts of data, such as media files or real-time streaming, with minimal latency. The P2P exchanges may be established through protocols that may include, for example, Wi-Fi Direct, where the STAs negotiate a direct link and manage their communication independently of the primary AP. The term “STA” may refer to any device that may have the capability to connect to a Wi-Fi network. STAs may include a wide range of client devices, for example, smartphones, laptops, tablets, smartwatches, Internet of Things (IoT) devices, printers, gaming consoles, or the like. The client devices may be end-user devices that access network services provided by an AP or a server.

An “AP” may refer to a network device that provides wireless connectivity to the client devices in the network. A Wi-Fi network may include a primary AP (e.g., a first AP, a reference AP, a central AP, or the like) and a plurality of neighboring APs. The primary AP may act as a central hub, managing communication between the STAs and providing access to the network. The primary AP and the plurality of neighboring APs may also include B nodes, radio network controllers (RNCs), Evolved B nodes, base station controllers (BSCs), base transceiver stations (BTSs), base stations (BSs), transceiver functions (TFs), Radio Routers, wireless sets, wireless local area network (LAN) controllers (WLCs), or the like. In an environment where many STAs are connected, the primary AP associated with the STAs can allocate specific channels or time slots for P2P communication among the STAs. In other words, the primary AP may provide the STA with network services that may include, for example, Internet access, file sharing, and other resources through an advertisement server (AS). The AS may be associated with the primary AP as well as the plurality of neighboring APs to provide network information and optimize connectivity for STAs. The AS may facilitate service discovery by offering details about available services, network capabilities, and roaming agreements through protocols that may include, for example, Generic Advertisement Service (GAS) and Access Network Query Protocol (ANQP). The AS may also share network quality metrics such as channel utilization and Quality of Service (QoS), aiding the STAs in selecting the most suitable AP for P2P exchange. The AS may support seamless roaming by providing information about neighboring APs and their conditions, enabling smooth handovers without connectivity loss. Additionally, the AS may assist in managing P2P communications by offering relevant network load and P2P service data.

In the network, the STA can either be in infrastructure mode (connecting to an AP) or ad-hoc/P2P mode (connecting directly with another STA). In several more embodiments, the STAs may further include a single radio. Hereinafter, the STAs may be referred to as the “client devices”. For the sake of brevity, the P2P communication is explained from the point of view of one client device. In various embodiments, the client device may include a processor, a transceiver, and a memory communicatively coupled to the processor. In many embodiments, the client device may be configured with a network interface controller (NIC) configured to provide access to the network. The client device may be further equipped with a P2P exchange logic. The P2P exchange logic may be internally or externally coupled to the client device. When the client device needs a P2P communication with another client device, the client device may be configured to transmit a P2P service request to a corresponding AP to establish a P2P communication as a service. The P2P service request may be transmitted via an ANQP request message. The “ANQP” may be a query sent to the primary AP by the client device to obtain network information, such as roaming partnerships, available services, or network authentication types, before associating with the primary AP.

In still more embodiments, the client device may be configured to receive an indication of support for generic advertisement service (GAS)/ANQP from the primary AP, and the P2P service request may be transmitted based on the indication of the support for GAS/ANQP. “GAS” may provide a framework for transmitting ANQP query and response messages between the client device and the primary AP. This is particularly useful in environments like hotspots where a client device needs to know more about the network (e.g., roaming partners, network costs, or available services) before connecting. In other words, the client device may be configured to detect whether the primary AP supports GAS/ANQP. Upon detecting such support, the client device can then transmit the P2P service request using GAS/ANQP, which allows the client device to efficiently discover and negotiate services provided by the network without prematurely associating with a potentially unsuitable AP.

In a number of embodiments, the primary AP (e.g. a first AP, a reference AP, or the like) may allocate one or more channels or time slots to the client device for enabling the P2P communication. However, the primary AP may also decline the P2P request due to network congestion or policy constraints. In such a scenario, the client device may receive from the primary AP, a list of one or more basic service set identifiers (BSSIDs) based on the transmitted P2P service request. A “BSSID” may refer to a unique identifier assigned to each Basic Service Set (BSS) in a Wi-Fi network. The BSSID may be a Media Access Control (MAC) address of an AP or the router that provides the Wi-Fi service. Each BSSID is used to uniquely identify a specific BSS in a network for enabling the client devices to connect to the correct AP and avoid interference from other nearby networks.

In several embodiments, the list of one or more BSSIDs may further include at least one of an indication of a P2P pair count or QoS basic service set (QBSS) load data associated with at least one of the one or more BSSIDs. The P2P pair count may indicate the number of P2P connections in the network. The “QBSS load” data may provide information about the current network load and quality in the network and may include metrics such as STA count (number of connected client devices), channel utilization (percentage of time the channel is in use), and available admission capacity (remaining capacity for additional traffic). In other words, the P2P pair count and the QBSS load data may provide metrics on the network load and capacity associated with each BSSID. In numerous embodiments, the client device may be configured to select a BSSID based on the list of one or more BSSIDs.

In several additional embodiments, the client device may further transmit a P2P scheduling request to an AP associated with the selected BSSID. The “P2P scheduling request” may be a communication mechanism that the client device may use to coordinate direct data transmissions with another client device over the network. When a P2P link is established between the two client devices, they often need to schedule their transmissions to avoid interference with other ongoing transmissions on the same or overlapping channels managed by the AP associated with the selected BSSID. The P2P scheduling request may therefore allow the client device to negotiate specific time slots for its P2P communication, ensuring efficient use of the available spectrum and reducing collisions with other client devices coupled to the AP associated with the selected BSSID.

In additional embodiments, in response to the transmission of P2P scheduling request by the client device to the AP associated with the selected BSSID, the client device may receive a P2P scheduling grant from the AP associated with the selected BSSID. A “P2P scheduling grant” may refer to a response provided by the AP associated with the selected BSSID that the P2P scheduling request is acknowledged and that specific time slots for data transmission between the client devices have been allocated. The P2P scheduling grant may help manage and optimize the use of available time and resources by scheduling when the client devices can send and receive data. In still additional embodiments, the client device may perform a P2P exchange based on the received P2P scheduling grant.

In more embodiments, the client device may transmit the P2P service request to the AS, via the primary AP. The primary AP may be different from the AP associated with the selected BSSID. Further, the P2P scheduling request may be transmitted to the AP associated with the selected BSSID via the primary AP through a link established between the primary AP and the AP associated with the selected BSSID. In still more embodiments, the client device may further support a multi-link operation (MLO). “MLO” may refer to a Wi-Fi 7 (802.11be) feature that allows one or more client devices to use multiple frequency bands (e.g., 2.4 GHz, 5 GHZ, and 6 GHz) simultaneously to increase throughput, reduce latency, and enhance reliability by aggregating links or switching between them dynamically.

In yet more embodiments, the selected BSSID may be associated with a lowest signal strength at the client device. In such scenarios, the client device may be configured to opt out of associating with the AP associated with the selected BSSID. In some more embodiments, the client device may select a channel devoid of any BSS. When such a channel cannot be found, the client device may choose an AP among the list of one or more BSSIDs having the lowest signal to minimize the P2P effect on the BSS and vice versa. The client device may thus send the P2P scheduling query to the AP, to request P2P scheduling.

In various embodiments, the client device may find the best channel for the P2P exchange without associating with the AP based on channel parameters having low channel usage (CU) and low P2P pair count. Therefore, the client device may proceed to the channel and perform the P2P exchange. However, P2P scheduling may decrease the risk of collisions with other client devices in the BSS. If the client device does not obtain a satisfactory P2P scheduling, the client device may drop off the P2P scheduling, and proceed directly for P2P exchange.

In further embodiments, the primary AP may include a processor, a memory, and an NIC configured to provide access to the network. The primary AP may be configured to receive the P2P service request from the client device. The P2P service request may be transmitted via an ANQP request message. In yet various embodiments, the ANQP request message may include a modular component of the ANQP protocol that may contain one or more sub-elements that specify different types of information being requested. The client device may request the necessary information through the one or more sub-elements of the ANQP request message. For P2P service discovery, one such sub-element may be utilized to request information about the “best” available BSSID. In still further embodiments, the primary AP may select one or more BSSIDs from a pool of BSSIDs associated with a neighbor AP list (e.g. the plurality of neighboring APs of the primary AP) based on the received P2P service request and at least one criterion. The at least one criterion may correspond to a P2P pair count associated with each of the selected one or more BSSIDs that may be less than a first threshold or a channel utilization measure that may be less than a second threshold. In a non-limiting example scenario, three BSSIDs may be available, where the first BSSID may have a P2P pair count of 3 and channel utilization of 35%, the second BSSID may have a P2P pair count of 2 and channel utilization of 60%, while the third BSSID may have a P2P pair count of 1 and channel utilization of 20%. If the client device has a policy to connect to a BSSID where the P2P pair count is less than 3 and the channel utilization is less than 40%, the client device may select the third BSSID. The third BSSID meets both conditions with a P2P pair count of 1 (less than 3) and a channel utilization of 20% (less than 40%), ensuring a less congested environment for the P2P communication. Thus, the AP may select the one or more BSSIDs based on the sub-element component of the ANQP request message that may correspond to the “best” BSSID(s)”. The best BSSID(s) may correspond to one or more most suitable AP or network segments to connect to or communicate with. The “best BSSID” can be defined by one or more criteria that may include, for example, signal strength, load, QoS, security, proximity, or the like.

In further additional embodiments, to determine the at least one criterion, the primary AP may receive, from each AP of one or more APs on the neighbor AP list, an indication of at least one of a P2P pair count associated with the reference AP or QBSS load data associated with the reference AP. The primary AP may further store the indication of at least one of the P2P pair count or the QBSS load data. In numerous additional embodiments, the primary AP may transmit the list of the selected one or more BSSIDs to the client device. The primary AP may further correspond to an AS or a WLC.

In several more embodiments, the AS coupled to the primary AP may be configured to perform one or more functionalities of the P2P exchange for the client device to establish a P2P communication. Therefore, the primary AP may be configured to transmit the P2P service request received from the client device to the AS. The primary AP may further transmit the indication of at least one of a P2P pair count or QBSS load data associated with the primary AP to the AS. The AS may be configured to select the list of one or more BSSIDs based on the P2P service request and transmit the list of one or more BSSIDs to the primary AP. The primary AP may be configured to forward the list of one or more BSSIDs to the client device that had transmitted the P2P service request.

Thus, facilitating ANQP-based assistance for P2P communications offers several advantages, including optimized network selection by allowing client devices to query APs for detailed information like signal strength, network load, and supported services before connecting. The ANQP-based assistance enhances service discovery and QoS by providing metrics that help client devices choose networks that meet their specific needs, improving performance for applications like streaming or gaming. The ANQP-based assistance further facilitates efficient roaming and connectivity by providing information about roaming agreements and authentication methods, ensuring stable P2P communication across different coverage areas. Moreover, the ANQP-based assistance reduces interference and network contention by guiding devices to less congested networks, leading to better battery management for resource-constrained devices and enabling the network to scale effectively in environments with many devices, such as smart homes and IoT ecosystems.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit. Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data. Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

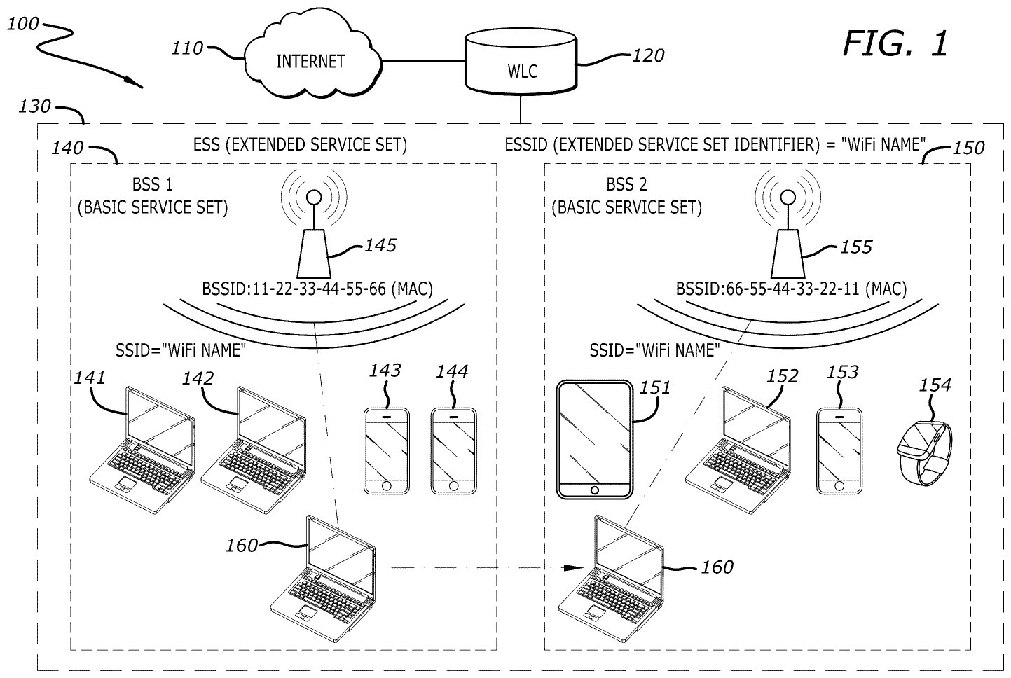

Referring to FIG. 1, a schematic block diagram of a wireless local networking system 100, in accordance with various embodiments of the disclosure is shown. Wireless local networking standards can play an important role in enabling seamless communication and connectivity between various devices within localized areas. One of the most prevalent standards is Wireless Fidelity (Wi-Fi), that is based on the IEEE 802.11 family of protocols. Wi-Fi provides high-speed wireless access to the Internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes—comprising devices like laptops, smartphones, or other Wi-Fi-enabled devices—operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A BSS may represent a subset within a service set, comprised of devices that share common physical-layer medium access characteristics. These characteristics include parameters such as radio frequency, modulation scheme, and security settings, ensuring seamless wireless networking among the devices. The BSS is uniquely identified by a basic service set identifier (BSSID), a 48-bit label adhering to medium access control (MAC)-48 conventions. Despite the possibility of a device having multiple BSSIDs, each BSSID is typically associated with, at most, one BSS at any given time.

It is important to note that a BSS should not be confused with the coverage area of an access point (AP), which is referred to as the basic service area (BSA). The BSA encompasses the physical space within which an AP provides wireless coverage, while the BSS focuses on the logical grouping of devices sharing common networking characteristics. This distinction emphasizes that the BSS is a conceptual grouping based on shared communication parameters, while the BSA defines the spatial extent of an AP's wireless reach. Understanding these distinctions is fundamental for effectively configuring and managing wireless networks, ensuring optimal performance and coordination among connected devices.

The SSID may define a service set or extend a service set. Normally, it is broadcast in the clear by stations in beacon packets to announce the presence of a network and is seen by users as a wireless network name. Unlike BSSIDs, SSIDs are usually customizable. Since the contents of an SSID field are arbitrary, the 802.11 standard permits devices to advertise the presence of a wireless network with beacon packets. A station (STA) may also likewise transmit packets in which the SSID field is set to null; this prompts an associated AP to send the STA a list of supported SSIDs. Once a device is associated with a BSS, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single AP. This network is created through the collaboration of multiple APs, presenting itself to users as a unified and continuous network experience. The ESS operates by integrating one or more infrastructure BSSs within a common logical network segment, characterized by sharing the same IP subnet and Virtual Local Area Network (VLAN).

The concept of an ESS is particularly advantageous in scenarios where a single AP cannot adequately cover the entire desired area. By employing multiple APs strategically, users can move seamlessly across the ESS without experiencing disruptions in connectivity. This is crucial for maintaining a consistent wireless experience in larger spaces, where users may transition between different physical locations covered by distinct APs.

Moreover, ESSs offer additional functionalities, such as distribution services and centralized authentication. The distribution services facilitate the efficient distribution of network resources and services across the entire ESS. Centralized authentication enhances security and simplifies access control by allowing users to authenticate once for access to any part of the ESS, streamlining the user experience and network management. Overall, ESSs provide a scalable and robust solution for ensuring reliable and comprehensive wireless connectivity in diverse and expansive environments.

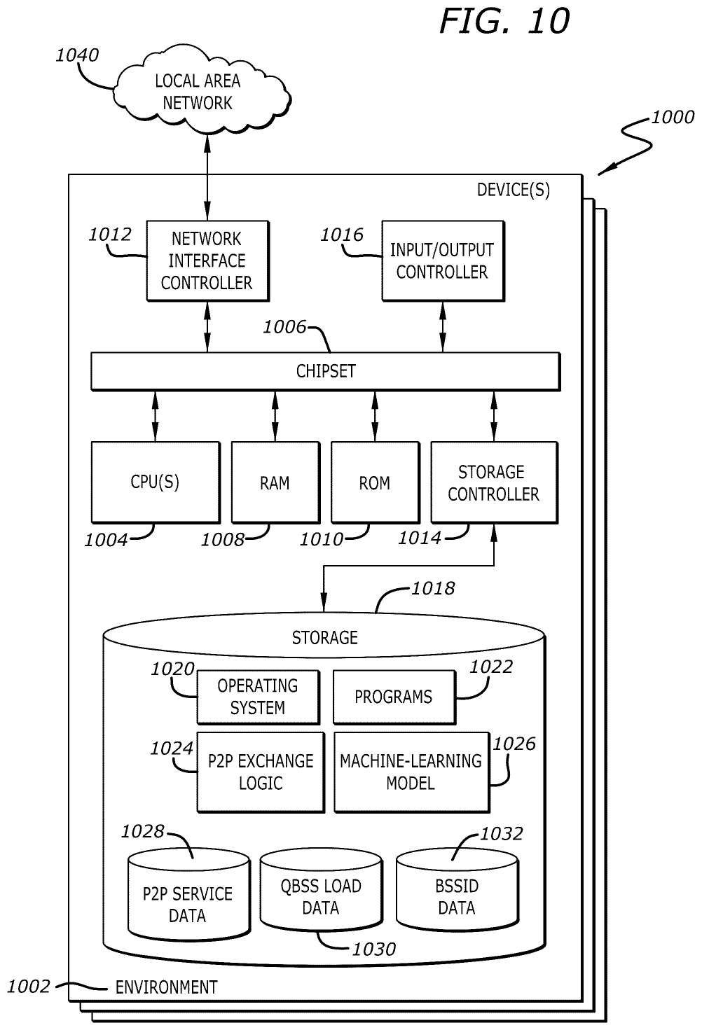

The network can include a variety of client devices that connect to the network. These devices can sometimes be referred to as STAs. Each device is typically configured with a MAC address in accordance with the IEEE 802.11 standard. As described in more detail in FIG. 10, various devices on a network can include components such as a processor, transceiver, user interface, etc. These components can be configured to process frames of data transmitted and/or received over the wireless network. APs are wireless devices configured to provide access to user end devices to a larger network, such as the Internet 110.

In the embodiment depicted in FIG. 1, a wireless network controller (shown as WLC) 120 is connected to a public network such as the Internet 110. The WLC 120 is in communication with an ESS (ESS 130). The ESS 130 comprises two separate BSSs (for example, a first BSS 140 and a second BSS 150). The ESS 130, the first BSS 140, and the second BSS 150 all broadcast and are configured with the same SSID “Wi-Fi Name”, which can be a BSSID for each of the first BSS 140 and the second BSS 150 as well as an ESSID for the ESS 130.

Within the first BSS 140, the network comprises a first notebook 141, a second notebook 142, a first phone 143, a second phone 144, and a third notebook 160. Each of these devices in the first BSS 140 can communicate with a first AP 145. Likewise, in the second BSS 150, the network comprises a first tablet 151, a fourth notebook 152, a third phone 153, and a first watch 154. Each of these devices in the second BSS 150 can communicate with a second AP 155. The third notebook 160 is communicatively connected to both the first BSS 140 and the second BSS 150. In this setup, the third notebook 160 can be seen to “roam” from the physical area serviced by the first BSS 140 and into the physical area serviced by the second BSS 150. These notebooks, the phones, the tablets, the watches, or the like may be referred to as client devices.

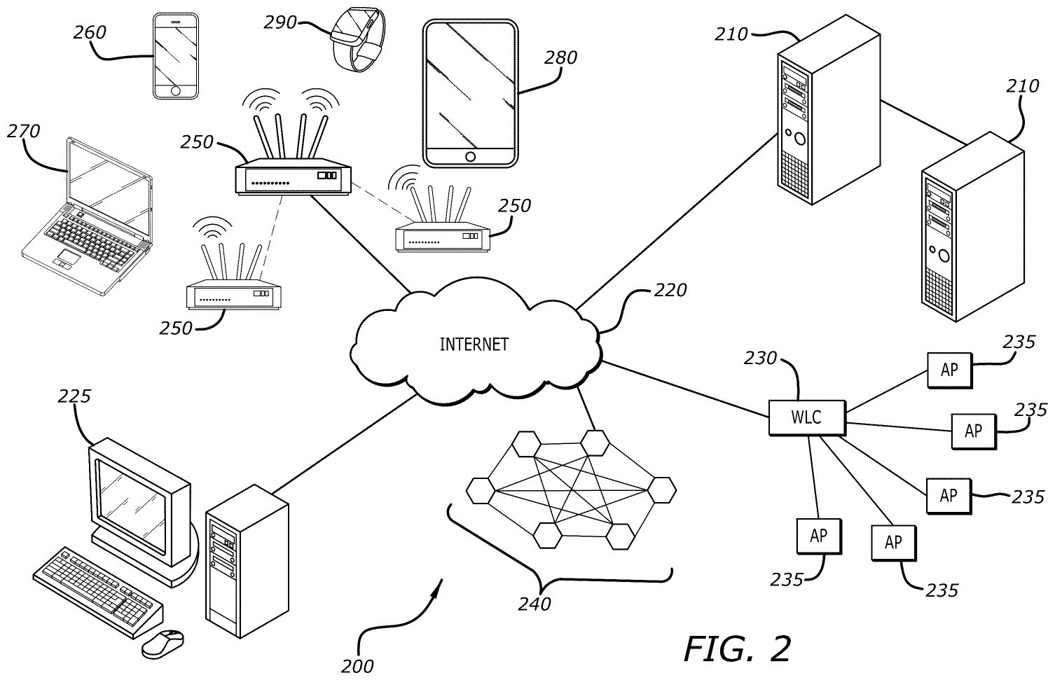

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-10 as required to realize a particularly desired embodiment.

Referring to FIG. 2, a conceptual network diagram of various environments that implement a peer-to-peer (P2P) exchange logic in accordance with various embodiments of the disclosure is shown. The P2P exchange logic can include various hardware and/or software deployments and can be configured in a variety of ways. In some non-limiting examples, the P2P exchange logic can be configured as a standalone device, exist as a logic within another network device, be distributed among various network devices operating in tandem, or remotely operated as part of a cloud-based network management tool. The embodiments shown in FIG. 2 illustrate a network 200 comprising a plurality of network devices that can implement the P2P exchange logic.

In many embodiments, the network 200 may include cloud-based centralized management servers 210 connected to a communication network 220 (shown as the Internet). The communication network 220 can include wired networks or wireless networks. The centralized management servers 210 can be configured to execute the P2P exchange logic. In a variety of embodiments, the network 200 may further include remote networks, such as, but not limited to a deployed network 240.

In a number of embodiments, the network 200 may include a plurality of network APs 250. The APs 250 may facilitate Wi-Fi connections for various electronic devices, such as but not limited to, client devices including laptop computers 270, cellular phones 260, portable tablet computers 280, and wearable computing devices 290. Each of the APs 250 can be configured to execute the P2P exchange logic for facilitating P2P communication for the client devices. However, in further embodiments, the P2P exchange logic may be operated as distributed logic across multiple APs 250. In the embodiment depicted in FIG. 2, the plurality of APs 250 can operate as the P2P exchange logic in a distributed manner or may have one specific AP (e.g., any of the APs 250) to implement the P2P exchange logic for the various APs (e.g., the APs 250).

In more embodiments, the network 200 may include a WLC 230 configured to monitor, control or manage APs 235 connected to the WLC 230, either wired or wirelessly. The WLC 230 and/or the APs 235 can be configured to execute the P2P exchange logic. The APs 235 may belong to one or more network clusters managed by one of the APs 250.

In still more embodiments, a personal computer 225 may be utilized to access and/or manage various aspects of the network 200, either remotely or within the network itself. In the embodiment depicted in FIG. 2, the personal computer 225 may communicate over the communication network 220 and can access the servers 210, the APs 250, or the WLC 230. Further, the P2P exchange logic may be operated via various client devices.

To facilitate ANQP-based P2P communication, the WLC 230 may be configured to maintain a neighbor AP list. The WLC 230 may be configured to receive and store AP-related utilization data from each neighboring AP (e.g., the APs 250 and the APs 235). The AP-related utilization data may include an indication of at least one of a P2P pair count or quality of service (QoS) basic service set (QBSS) load data associated with an AP. The P2P pair count may indicate the number of P2P connections associated with the AP in the network 200. The QBSS load data may provide information about the current network load and quality associated with the AP in the network 200. In an example, the QBSS load data may include station count, channel utilization, and available admission capacity.

For the sake of brevity, the P2P communication is explained from the point of view of one client device. When the client device needs a P2P communication with another client device, the client device may be configured to generate and transmit a P2P service request to one AP (e.g., any of the APs 250). Hereinafter, the AP receiving the P2P service request may be referred to as the “primary AP”. The P2P service request may be transmitted via an access network query protocol (ANQP) request message. ANQP is a query sent to an AP by the client device to obtain network information, such as roaming partnerships, available services, or network authentication types, before associating with the AP. In many embodiments, the ANQP request message may include a modular component of the ANQP protocol that may contain one or more sub-elements that specify different types of information being requested. The modular component allows the one or more client devices to request only the necessary information, reducing network overhead and response times. For P2P service discovery, one such sub-element may be used to request information about the best available BSSIDs.

In still more embodiments, the client device may be configured to receive an indication of support for generic advertisement service (GAS) or ANQP from the primary AP. The P2P service request may be transmitted based on the indication of the support for GAS or ANQP. GAS may provide a framework for transmitting ANQP query and response messages between the client device and the primary AP. This is particularly useful in environments like hotspots where a client device needs to know more about the network (e.g., roaming partners, network costs, or available services) before connecting. In other words, the client device may be configured to detect whether an AP supports GAS or ANQP and transmit the P2P service request using GAS or ANQP upon detecting such support. This allows the client device to efficiently discover and negotiate services provided by the network or other devices without prematurely associating with a potentially unsuitable AP.

In a number of embodiments, the primary AP may allocate one or more channels or time slots to the client device for enabling the P2P communication. However, the primary AP may also decline the P2P request due to network congestion or policy constraints. In such a scenario, the primary AP may be configured to receive the P2P service request from the client device. The primary AP may forward the P2P service request to the WLC 230. In still further embodiments, the WLC 230 may select one or more BSSIDs from a pool of BSSIDs associated with the neighbor AP list based on the received P2P service request and at least one criterion. Thus, the one or more BSSIDs are selected based on the sub-element component of the ANQP request message that may correspond to the best available BSSIDs. Further, the at least one criterion may correspond to a P2P pair count being less than a first threshold and/or a channel utilization measure being less than a second threshold. In several embodiments, the list of one or more BSSIDs may further include at least one of an indication of a P2P pair count or QBSS load data associated with at least one of the one or more BSSIDs. In other words, the P2P pair count or the QBSS load data may provide metrics on the network load and capacity associated with each BSSID (e.g., an AP associated with each BSSID). In numerous additional embodiments, the WLC 230 may transmit the list of the selected one or more BSSIDs to the primary AP. The primary AP may then transmit the list of the selected one or more BSSIDs to the client device.

The client device may thus receive the list of the selected one or more BSSIDs based on the transmitted P2P service request. The one or more BSSIDs are associated with APs that are suitable for the P2P communication. In numerous embodiments, the client device may be configured to select a BSSID based on the list of one or more BSSIDs. The client device may further transmit a P2P scheduling request to an AP associated with the selected BSSID. The AP associated with the selected BSSID may be different from the primary AP.

In additional embodiments, in response to the transmission of P2P scheduling request by the client device to the AP associated with the selected BSSID, the client device may be configured to receive a P2P scheduling grant from the AP. A P2P scheduling grant may refer to a mechanism used in P2P communication to allocate specific time slots for data transmission between devices. It helps manage and optimize the use of available time and resources by scheduling when network devices can send and receive data, reducing contention and improving overall network efficiency. In still additional embodiment, the client device may perform a P2P exchange based on the received P2P scheduling grant.

Although a specific embodiment for a conceptual network diagram of various environments that implement a P2P exchange logic suitable for carrying out the various steps, processes, methods, and operations described herein is discussed with respect to FIG. 2, any of a variety of systems and/or processes may be utilized in accordance with embodiments of the disclosure. For example, the functions of the WLC 230 may be performed by an advertisement server. The elements depicted in FIG. 2 may also be interchangeable with other elements of FIG. 1 and FIGS. 3-10 as required to realize a particularly desired embodiment.

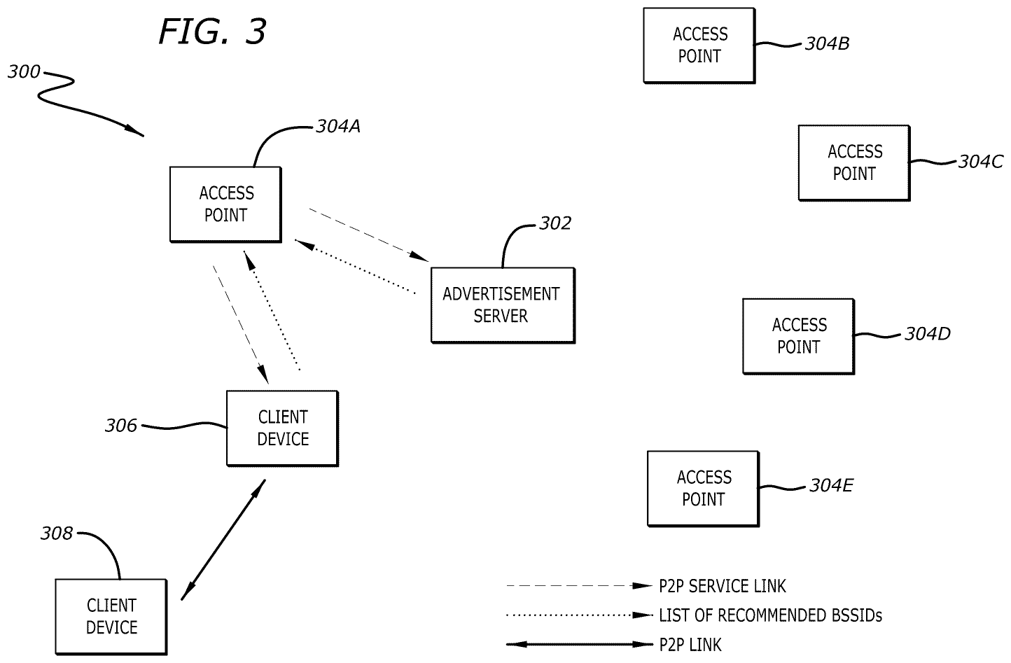

Referring to FIG. 3, a schematic block diagram of an example network 300 in accordance with various embodiments of the disclosure is shown. The network 300 can refer to a high-speed, high-bandwidth interconnect system that enables multiple devices to communicate with each other efficiently and reliably. The network 300 may correspond to a wireless network facilitating P2P communication among a plurality of client devices in a given area. In many embodiments, the network 300 may include an advertisement server (AS) 302, various APs 304A, 304B, 304C, 304D, and 304E (collectively referred to as “304A-E”), and client devices 306 and 308 coupled to each other.

The AS 302 in the example architecture shown in FIG. 3 may be a centralized server that provides network-related information and services to the client devices 306 and 308 via the APs 304A-E. The AS 302 may work with the APs 304A-E to respond to ANQP request messages from the client devices 306 and 308. The AS 302 can provide details such as network capabilities, roaming agreements, QoS metrics, available services, or the like.

In a variety of embodiments, the APs 304A-E may connect the client devices 306 and 308 to a broader network, such as the Internet or an internal LAN. Further, the APs 304A-E may support GAS or ANQP, thereby providing network and service discovery information to the client devices 306 and 308 and facilitating better network selection and connectivity management. In a number of embodiments, the APs 304A-E may be part of the same network or nearby networks. Each of the APs 304A-E may have its own BSSID. The BSSID is a unique identifier (e.g. a MAC address) of an AP or a network segment within a Wi-Fi network. A BSSID may help to distinguish between different APs broadcasting the same SSID in the network 300, ensuring that client devices connect to the correct AP. A single SSID can have multiple BSSIDs associated with it if there are multiple APs providing coverage for the same network (e.g., a mesh network or an enterprise network with multiple APs).

The client devices 306 and 308 may be Wi-Fi-enabled end user devices that access the network services provided by an AP or a server (e.g., the AS 302). The client devices may also be referred to as STAs. An STA may refer to any device that has the capability to connect to a Wi-Fi network and may include, for example, smartphones, laptops, tablets, smartwatches, Internet of Things (IoT) devices, printers, gaming consoles, or the like. Since STAs are the devices that connect to an AP to access network resources, they are categorized as client devices. The client devices 306 and 308 may establish a P2P link between each other, enabling direct communication without the need for traffic to pass through the AS 302 or any of the APs 304A-E. This P2P link allows them to share data, stream media, or perform other tasks directly.

In various embodiments, each of the AS 302, the APs 304A-E, and the client devices 306 and 308 may include a processor, a network interface controller (NIC) configured to provide access to the network 300, a transceiver, and a memory communicatively coupled to the processor. The memory of each of the AS 302, the APs 304A-E, and the client devices 306 and 308 may include a P2P exchange logic that is configured to enable P2P communication between the client devices 306 and 308. P2P communication may need the help of APs for various tasks, such as service discovery and obtaining network information, providing QoS data to optimize P2P link quality, assisting in P2P group formation by coordinating roles in dense networks, managing network resources to prevent interference between P2P and AP-based communications, support roaming by guiding client devices to the best APs, and enhance security by facilitating secure key exchanges. Additionally, in crowded environments, the APs manage channel assignments to optimize P2P performance and reduce interference, ensuring efficient and reliable communication.

To facilitate the P2P communication between the client devices 306 and 308, the AS 302 may be configured to maintain a neighbor AP list. The AS 302 may be configured to receive, from each AP on the neighbor AP list, an indication of at least one of a P2P pair count associated with the AP or QBSS load data associated with the AP. The indication may be received at periodic intervals. Alternatively, the AS 302 may be configured to query the neighboring APs to obtain the requisite information. Further, the AS 302 may be configured to store the indication of at least one of the P2P pair count or the QBSS load data. The indication may be stored in the memory of the AS 302. The P2P pair count may indicate the number of P2P connections associated with an AP in the network 300. The QBSS load data may provide information about the current network load and quality of the AP in the network 300. The QBSS load data may include station count, channel utilization, and available admission capacity.

When the client device 306 requires a P2P communication, the client device 306 may be configured to generate and transmit a P2P service request to an AP (e.g., the AP 304A). The P2P service request may be transmitted via an ANQP request message. ANQP is a query sent to an AP by a client device to obtain network information, such as roaming partnerships, available services, or network authentication types, before associating with the AP. In many embodiments, the ANQP request message may include a modular component of the ANQP protocol that may contain one or more sub-elements that specify different types of information being requested. The modular component allows client devices to request only the necessary information, reducing network overhead and response times. For P2P service discovery, one such sub-element may be used to request information about the best available BSSIDs.

The client device 306 may be configured to receive an indication of support for GAS or ANQP from the AP 304A, and the P2P service request may be transmitted based on the indication of the support for GAS or ANQP. The support for GAS or ANQP may be received by way of a beacon response or a probe response. GAS may provide a framework for transmitting ANQP query and response messages between client devices and APs. This is particularly useful in environments like hotspots where a client device needs to know more about a network (e.g., roaming partners, network costs, or available services) before connecting. This allows the client device to efficiently discover and negotiate services provided by the network or other devices without prematurely associating with a potentially unsuitable AP.

In a number of embodiments, the AP 304A may be configured to forward the P2P service request to the AS 302. The AS 302 may thus be configured to receive the P2P service request. Further, the AS 302 may be configured to select one or more BSSIDs from a pool of BSSIDs associated with the neighbor AP list based on the received P2P service request and at least one criterion. Based on the at least one criterion, each of the selected one or more BSSIDs is associated with a P2P pair count that is less than a first threshold or a channel utilization measure that is less than a second threshold. In an example, the first threshold may correspond to three and the second threshold may correspond to 40%. However, the first and second thresholds may be different in various embodiments.

The AS 302 may be configured to transmit a list of the selected one or more BSSIDs to the AP 304A. In several embodiments, the list of the selected one or more BSSIDs may further include at least one of an indication of the P2P pair count or the QBSS load data associated with at least one of the selected one or more BSSIDs. In other words, the P2P pair count or the QBSS load data may provide metrics on the network load and capacity associated with each BSSID (e.g., an AP associated with each BSSID). The AP 304A may be configured to transmit the list of the selected one or more BSSIDs to the client device 306 as a response for the P2P service request. The client device 306 may thus be configured to receive the list of one or more BSSIDs based on the transmitted P2P service request. The P2P service request is transmitted by the client device 306 to the AS 302 via the AP 304, and the list of one or more BSSIDs is received by the client device 306 from the AS 302 via the AP 304A.

In numerous embodiments, the client device 306 may be configured to select a BSSID based on the list of one or more BSSIDs. In numerous additional embodiments, the selected BSSID is on the list of one or more BSSIDs. An AP associated with the selected BSSID may be any of the APs 304A-E (e.g., may be same or different from the AP communicating the P2P service request). The scope of the present disclosure is not limited to the client device 306 selecting the BSSID based on the data received from the AS 302. In further additional embodiments, the client device 306 may select one BSSID from the list of one or more BSSIDs based on a set of rules defined for the client device 306.

In many embodiments, the client device 306 may be configured to associate with the AP associated with the selected BSSID. The AP associated with the selected BSSID is hereinafter referred to as the “selected AP”. In yet more embodiments, the client device 306 may include a single radio that facilitates the association with the selected AP. Further, the client device 306 may be configured to transmit a P2P scheduling request to the selected AP to request scheduling. In additional embodiments, in response to the transmission of the P2P scheduling request, the client device 306 may be configured to receive a P2P scheduling grant from the selected AP. A P2P scheduling grant may refer to a mechanism used in P2P communication to allocate specific time slots for data transmission between devices. It helps manage and optimize the use of available time and resources by scheduling when network devices can send and receive data, reducing contention and improving overall network efficiency. In still additional embodiment, the client device 306 may be configured to perform a P2P exchange with the client device 308 based on the received P2P scheduling grant.

The scope of the present disclosure is not limited to the client device 306 associating with the selected AP. In several more embodiments, the client device 306 may not associate with any AP. In other words, the client device 306 may be configured to opt out of associating with any AP. In such a scenario, the client device 306 may be configured to identify a channel devoid of any BSS for performing the P2P exchange with the client device 308. If the client device 306 is unable to identify the channel devoid of BSS, the client device 306 may be configured to select an AP with the lowest signal strength and transmit the P2P scheduling request to such an AP. The lowest signal strength may correspond to the lowest P2P count and/or the lowest channel utilization measure among the APs 304A-E. Selecting an AP with the lowest signal strength may minimize the P2P effect on the BSS.

In several additional embodiments, whilst direct P2P exchanges may be possible upon identification of available channels, the client device 306 may avoid direct P2P exchange to reduce the risk of collisions with other client devices in the selected BSSs. Instead, the client device 306 may transmit the P2P scheduling request to the AP with the lowest signal strength to request scheduling. In further embodiments, if the client device 306 is unable to obtain satisfactory scheduling, the client device 306 may be configured to drop off the scheduling structure and proceed directly to the P2P exchange.

In still more embodiments, the client device 306 may support a multi-link operation (MLO). MLO may refer to a Wi-Fi 7 (802.11be) feature that allows one or more client devices to use multiple frequency bands (e.g., 2.4 gigahertz (GHz), 5 GHz, and 6 GHz) simultaneously to increase throughput, reduce latency, and enhance reliability by aggregating links or switching between them dynamically. In such a scenario, the client device 306 may be configured to associate with an AP that is different from the AP associated with the selected BSSID. The AP with which the client device 306 associates may be the most suitable AP in the network 300. The suitability of the AP may be defined based on the signal strength, QoS, or the like.

In some more embodiments, the P2P scheduling request may be transmitted to the selected AP via a different AP and a link between the AP and the selected AP. For example, if the AP 304C is the selected AP and the client device 306 has an active connection to the AP 304A, the P2P scheduling request may be transmitted to the AP 304C via the AP 304A and a link between the AP 304A and the AP 304C.

Although a specific embodiment for the example network 300 suitable for carrying out the various steps, processes, methods, and operations described herein is discussed with respect to FIG. 3, any of a variety of systems and/or processes may be utilized in accordance with embodiments of the disclosure. For example, the operations of the AS 302 may be performed by a WLC or an AP. The elements depicted in FIG. 3 may also be interchangeable with other elements of FIGS. 1-2 and FIGS. 4-10 as required to realize a particularly desired embodiment.

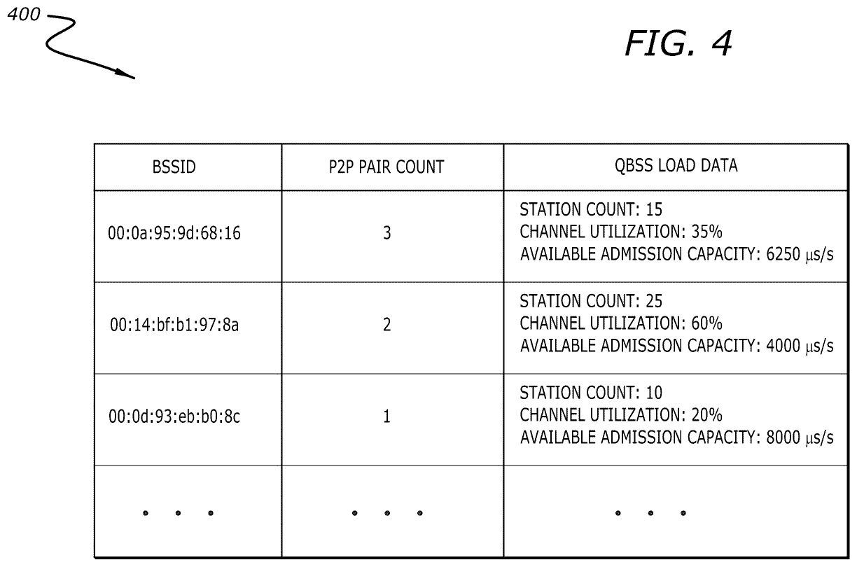

Referring to FIG. 4, a conceptual diagram of an example Table 400 in accordance with various embodiments of the disclosure is shown. Table 400 may highlight network load and the availability of different APs to handle additional traffic or P2P connections. Table 400 shows BSSIDs, P2P pair count, and QBSS load data associated with various APs of a network. Table 400 may be used in a Wi-Fi network to indicate the status of different APs or network segments, and how they might impact P2P communication. In many embodiments, the Wi-Fi network may include an advertisement server (AS), APs, and client devices. A client device requiring a P2P communication with another client device may transmit a P2P service request to the AS via an AP. The AS may transmit, to the client device via the AP, the list illustrated in Table 400 as the response to the P2P service request. Based on Table 400, the client device may select a BSSID, and in turn, the AP, for P2P communication.

In an example embodiment, the first column of Table 400 shows three different BSSIDs (00:0a:95:9d:68:16, 00:14:bf:b1:97:8a, and 00:0d:93:eb:b0:8c). Each BSSID may represent a different AP or network segment. The second column of Table 400 shows a P2P pair count. In other words, the column represents the number of P2P pairs or connections associated with each BSSID/AP. A P2P pair count may refer to the number of active P2P connections or links associated with a particular BSSID. The P2P pair count indicates how many client device pairs are directly communicating with each other without going through an AP. This count is important for understanding the network load and the level of P2P activity in the vicinity of the AP. For example, the AP with BSSID 00:0a:95:9d:68:16 has 3 P2P pairs, the AP with BSSID 00:14:bf:b1:97:8a has 2 P2P pairs, and the AP with BSSID 00:0d:93:eb:b0:8c has 1 P2P pair. A higher P2P pair count may indicate a more congested network or a higher number of direct device-to-device connections using that AP's resources.

The third column of the table 400 highlights the QBSS load data that provides information about the load on each AP, which helps in determining the capacity and performance of the network. The QBSS load data may include three sub-elements such as STA count, channel utilization, and available admission capacity. The STA may also be referred to as the client devices. The STA count may refer to the number of stations connected to the BSSID/AP. For instance, the AP with BSSID 00:0a:95:9d:68:16 has 15 connected STAs, the AP with BSSID 00:14:bf:b1:97:8a has 25 connected STAs or client devices, whereas the AP with BSSID 00:0d:93:eb:b0:8c has 10 connected STAs. The channel utilization component of the QBSS load may refer to the percentage of channel usage or how much of the available radio frequency is currently being used. Higher values indicate more congestion. For example, the AP with BSSID 00:0a:95:9d:68:16 has 35% channel utilization, the AP with BSSID 00:14:bf:b1:97:8a has 60% channel utilization, and the AP with BSSID 00:0d:93:eb:b0:8c has 20% channel utilization. The available admission capacity component of the QBSS load may indicate a remaining capacity (in microseconds per second, μs/s) available for new traffic or connections. Lower values may mean the network is closer to its capacity. For example, the available admission capacity of the AP with BSSID 00:0a:95:9d:68:16 is 6250 μs/s, the AP with BSSID 00:14:bf:b1:97:8a is 4000 μs/s, and the AP with 00:0d:93:eb:b0:8c is 4000 μs/s.

In additional embodiments, when the client device receives the list as illustrated in the table 400, the client device may select the AP with the BSSID 00:0d:93:eb:b0:8c as the AP has less STA count and channel utilization and higher available admission capacity. Further, the client device may transmit a P2P scheduling request to the AP with the BSSID 00:0d:93:eb:b0:8c. Based on a P2P scheduling grant from the AP with the BSSID 00:0d:93:eb:b0:8c, the client device may perform P2P exchange with other client devices.

Although a specific embodiment for the example table 400 suitable for carrying out the various steps, processes, methods, and operations described herein is discussed with respect to FIG. 4, any of a variety of systems and/or processes may be utilized in accordance with embodiments of the disclosure. In many non-limiting examples, other performance metrics that are different from channel utilization measure may be utilized for the BSSID selection. The elements depicted in FIG. 4 may also be interchangeable with other elements of FIGS. 1-3 and FIGS. 5-10 as required to realize a particularly desired embodiment.

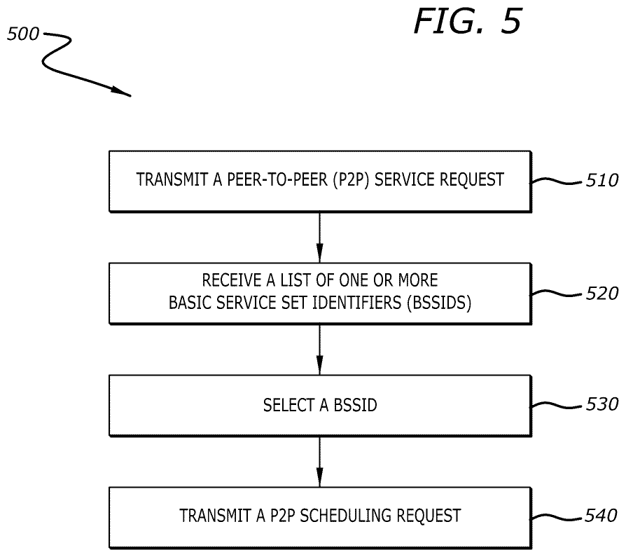

Referring to FIG. 5, a flowchart depicting a process for ANQP-based assistance for P2P exchange scheduling in accordance with various embodiments of the disclosure. The process 500 for P2P scheduling may be performed by a client device of a network. In many embodiments, the process 500 may transmit a P2P service request (block 510). The process 500 may transmit the P2P service request to an AP. The P2P service request may include information about the desired services or the specific requirements of the client device, such as bandwidth needs, latency constraints, or preferred P2P partners. The process 500 may enable the client device to signal the need for P2P communication and to solicit network-related information from the AP, which can aid in selecting the most suitable AP for establishing a P2P connection.

In a number of embodiments, the process 500 may receive a list of one or more BSSIDs (block 520). The list of BSSIDs may be received as a response to the P2P service request. The list may provide additional information associated with each BSSID, such as the number of current P2P pairs and QBSS load data.

In a variety of embodiments, the process 500 may select a BSSID (block 530). The BSSID may be selected based on the list of one or more BSSIDs and the associated network data. The selection process involves evaluating factors such as the number of current P2P pairs, the channel utilization rate, station count, and available admission capacity. The goal may be to choose an AP with a low network load, high available capacity, and optimal conditions for P2P communication. The selected BSSID may serve as the intermediary or facilitator of the P2P connection, ensuring efficient and seamless data transmission between the peer devices.

In still additional embodiments, the process 500 may transmit a P2P scheduling request (block 540). The P2P scheduling request may be transmitted to an AP associated with the selected BSSID. The P2P scheduling request may indicate an intention of the client device to establish the P2P connection and may include scheduling information, such as the desired time slots, duration, and priority of the communication. The P2P scheduling request may enable the AP associated with the selected BSSID to manage its resources efficiently and allocate the necessary bandwidth and time slots for the P2P communication while maintaining the overall QoS for other client devices connected to the AP associated with the selected BSSID. Upon receiving the scheduling request, the AP associated with the selected BSSID may coordinate the P2P communication and provide feedback or approval to the client devices, allowing them to establish a direct link for data exchange.

Although a specific embodiment for ANQP-based assistance for P2P exchange scheduling suitable for carrying out the various steps, processes, methods, and operations described herein is discussed with respect to FIG. 5, any of a variety of systems and/or processes may be utilized in accordance with embodiments of the disclosure. For example, the process 500 may opt out of associating with the AP associated with the selected BSSID. The elements depicted in FIG. 5 may also be interchangeable with other elements of FIGS. 1-4 and 6-10 as required to realize a particularly desired embodiment.

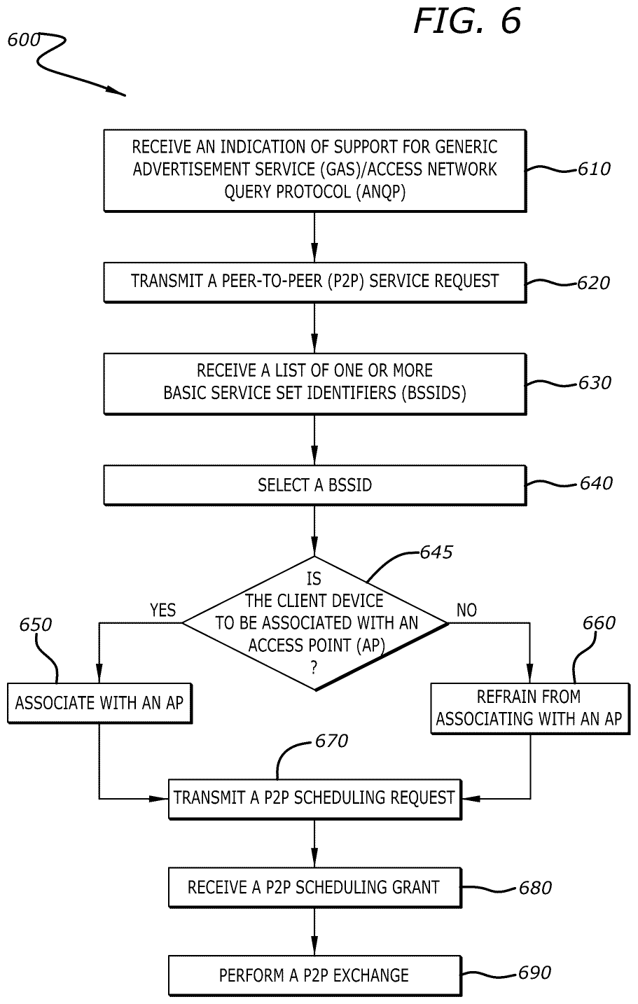

Referring to FIG. 6, a flowchart showing a process 600 for ANQP-based assistance for P2P exchange scheduling in accordance with various embodiments of the disclosure. The process 600 for P2P exchange scheduling may be performed by a client device of a network. In many embodiments, the process 600 may receive an indication of support for GAS or ANQP (block 610). The indication of support for GAS or ANQP may be received from an AP (hereinafter referred to as “primary AP”). GAS may refer to a framework for transmitting ANQP query and response messages between client devices and the AP so that the client devices obtain network parameters (e.g., roaming partners, network costs, or available services) before connecting.

In a number of embodiments, the process 600 may transmit a P2P service request (block 620). The P2P service request may be transmitted to the primary AP upon indication of the support for GAS/ANQP from the primary AP. The P2P service request may be transmitted using GAS or ANQP, which allows the client device to efficiently discover and negotiate services provided by the network or other client devices without prematurely associating with a potentially unsuitable AP. In other words, the process 600 may detect whether the primary AP supports GAS/ANQP prior to transmitting the P2P service request. In yet various embodiments, the ANQP request message may include a modular component of the ANQP protocol that may contain one or more sub-elements that specify different types of information being requested. The client device may request the necessary information through the one or more sub-elements of the ANQP request message. For P2P service discovery, one such sub-element may be utilized to request information about the “best” available BSSID.

In a variety of embodiments, the process 600 may receive a list of one or more BSSIDs (block 630). The list of one or more BSSIDs may be received from the primary AP based on the transmitted P2P service request. The list of one or more BSSIDs may be generated by an advertisement server that maintains a neighbor AP list. The one or more BSSIDs are associated with APs that are suitable for facilitating P2P connection. In several embodiments, the list of one or more BSSIDs may further include at least one of an indication of a P2P pair count or QBSS load data associated with at least one of the one or more BSSIDs.

In still more embodiments, the process 600 may select a BSSID (block 640). The BSSID may be selected based on the list of one or more BSSIDs and the associated network data. The selection process involves evaluating factors such as the number of current P2P pairs, the channel utilization rate, station count, and available admission capacity. The goal may be to choose an AP with a low network load, high available capacity, and optimal conditions for P2P communication. The selected BSSID may serve as the intermediary or facilitator of the P2P connection, ensuring efficient and seamless data transmission between the peer devices. In various embodiments, the selected BSSID may be associated with a lowest signal strength at the client device.

In yet more embodiments, the process 600 may determine if the client device is to be associated with an AP (block 645). In other words, the client device may associate with a selected AP (e.g., the AP associated with the selected BSSID) to gain access to a broader network, such as the Internet or an internal LAN, which enables them to communicate beyond their immediate vicinity. Associating with an AP provides stable connectivity, enhanced signal strength, and access to network services like data exchange, voice, and video streaming.

Thus, if the client device is to be associated with the selected AP, in further embodiments, the process 600 may associate with the AP (block 650). In other words, the process 600 may associate with the AP corresponding with the selected BSSID. Associating with the AP with the selected BSSID may enable the client device to communicate beyond the immediate vicinity of the client device while providing a stable connectivity, enhanced signal strength, and access to network services like data exchange, voice, and video streaming. In yet various embodiments, the client device may support an MLO. In such a scenario, the client device may also associate with another AP that is different from the AP associated with the selected BSSID. For example, the other AP with which the client device 306 associates may be the most suitable AP in the network for communication. The suitability of the AP may be defined based on the signal strength, QoS, or the like.

However, if the client device is not to be associated with the AP corresponding to the selected BSSID, in still further embodiments, the process 600 may opt out from associating with the AP corresponding to the selected BSSID (block 660). That is to say, if the selected BSSID is associated with a weakest signal strength at the client device, the client device may opt out of associating with the AP corresponding to the selected BSSID. Opting out of associating with the AP may involve deliberate avoidance of connection to the selected AP, even if the selected AP is within range and available for association. This decision may be based on factors such as the AP's high channel utilization, QoS, low available admission capacity, or the preference of the client device for maintaining a direct P2P link with another client device without interference. By choosing to opt out of associating with the selected AP, the client device can prioritize efficient P2P communication or avoid connecting to an overloaded or unsuitable AP.

In still additional embodiments, after associating with the selected AP or opting out of the association, the process 600 may transmit a P2P scheduling request (block 670). The P2P scheduling request may be transmitted to the selected AP. The P2P scheduling request may be a communication mechanism that the client device may use to coordinate direct data transmissions with another client device over the network. When a P2P link is established between the two client devices, they often need to schedule their transmissions to avoid interference with other ongoing transmissions on the same or overlapping channels managed by an AP. The P2P scheduling request may therefore allow the client device to negotiate specific time slots for its P2P communication, ensuring efficient use of the available spectrum and reducing collisions with other client devices associated with the selected AP.

In several additional embodiments, the process 600 may receive a P2P scheduling grant (block 680). The P2P scheduling grant may be received from the selected AP. In other words, the P2P scheduling grant from the selected AP may mean that the selected AP has acknowledged the specific time slots proposed by the client device through the P2P scheduling request. Accordingly, on receipt of the P2P scheduling grant, the specific time slots can be allocated for data transmission between the client devices requested.

In further additional embodiments, the process 600 may perform a P2P exchange (block 690). The process 600 may perform the P2P exchange based on the received P2P scheduling grant. In other words, the process 600 may provide direct communication between two client devices in a network, allowing them to share data without the need to route traffic through the selected AP. The P2P exchange may enable the client devices to transfer large amounts of data, such as media files or real-time streaming, with minimal latency. The P2P exchanges may be established through protocols like Wi-Fi Direct, where the client devices negotiate a direct link and manage their communication independently of the AP. During a P2P exchange, the process 600 may coordinate the transmission schedules to avoid interference with other network traffic

Although a specific embodiment for ANQP-based assistance for P2P exchange suitable for carrying out the various steps, processes, methods, and operations described herein is discussed with respect to FIG. 6, any of a variety of systems and/or processes may be utilized in accordance with embodiments of the disclosure. For example, after opting out of associating with the selected AP, process 600 may select a channel devoid of any BSS. When such channel cannot be found, the process 600 may choose an AP with the lowest signal to minimize the P2P effect on the BSS and vice versa. The process 600 may send a P2P scheduling query to such an AP to request scheduling. The elements depicted in FIG. 6 may also be interchangeable with other elements of FIGS. 1-5, and FIGS. 7-10 as required to realize a particularly desired embodiment.

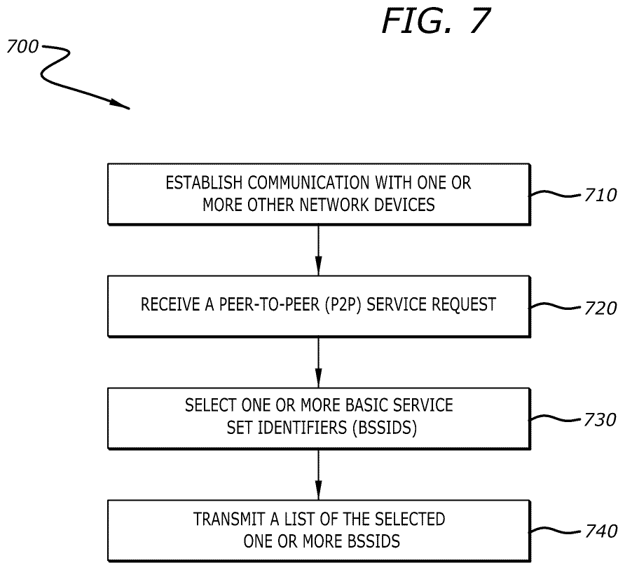

Referring to FIG. 7, a flowchart showing a process 700 for P2P exchange scheduling with ANQP-based assistance in accordance with various embodiments of the disclosure is shown. The process 700 may be performed at an AS communicatively coupled to a plurality of APs. In many embodiments, the process 700 may establish communication with one or more other network devices (block 710). The one or more network devices may include, for example, one or more APs. The APs may communicate AP-related network utilization data to the AS at periodic intervals.

In a numerous additional embodiment, the process 700 may receive a P2P service request (block 720). The P2P service request is transmitted by a client device via an ANQP request message and received by the AS, via an associated AP. The P2P service request may include information about the desired services or the specific requirements of the client device, such as bandwidth needs, latency constraints, or preferred P2P partners. For example, the P2P service request may include a request for best available BSSIDs for P2P communication by the client device.

In a number of embodiments, the process 700 may select one or more BSSIDs (block 730). In still further embodiments, the process 700 may select the one or more BSSIDs from a pool of BSSIDs associated with a neighbor AP list based on a received P2P service request and at least one criterion. Thus, the process 700 may select the one or more BSSIDs based on the sub-element component of the ANQP request message that may correspond to the best BSSID(s) pointing to one or more most suitable APs or network segments to connect to or communicate with. The best BSSIDs can be defined by one or more criteria that may include, for example, signal strength, load, QoS, security, proximity, or the like. Further, the at least one criterion may correspond to a P2P pair count being less than a first threshold or a channel utilization measure being less than a second threshold.

In a variety of embodiments, the process 700 may transmit the list of the selected one or more BSSIDs (block 740). Thus, the list of the selected one or more BSSIDs may be transmitted to the client device via the associated AP. Based on the list, the client devices may select a potential AP associated with a most suitable BSSID to enable the P2P communication.

Although a specific embodiment for ANQP-based assistance for P2P exchange scheduling suitable for carrying out the various steps, processes, methods, and operations described herein is discussed with respect to FIG. 7, any of a variety of systems and/or processes may be utilized in accordance with embodiments of the disclosure. For example, the process 700 may be performed at any WLC or any server that manages a plurality of APs. The elements depicted in FIG. 7 may also be interchangeable with other elements of FIGS. 1-6, and FIGS. 8-10 as required to realize a particularly desired embodiment.

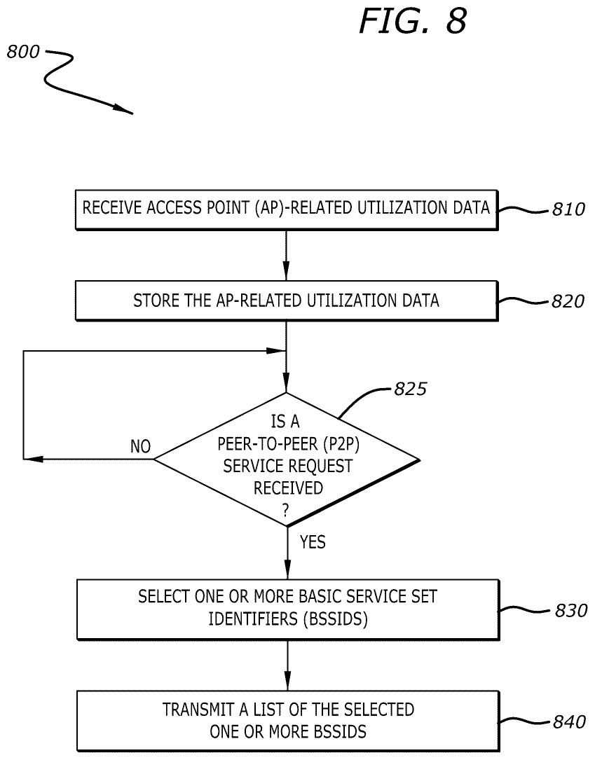

Referring to FIG. 8, a flowchart showing a process 800 for P2P exchange scheduling with ANQP-based assistance in accordance with various embodiments of the disclosure is shown. The process 800 may be performed at an AS or WLC communicatively coupled to a plurality of APs. In many embodiments, the process 800 may receive AP-related utilization data (block 810). The process 800 may receive the AP-related utilization data from the plurality of APs associated with the AS. The AP-related utilization data may include metrics such as channel utilization and STA count. The channel utilization may show the percentage of time the channel is occupied with traffic, wherein the STA count may indicate the number of client devices connected to an AP. Additionally, the AP-related utilization data may include available admission capacity, which reflects the remaining bandwidth or resources available for new connections or additional traffic.

In a variety of embodiments, the process 800 may store the AP-related utilization data (block 820). The AP-related utilization data may be stored in a memory associated with the AS. By maintaining information on metrics such as channel utilization, station count, and available admission capacity for each AP, the AS can provide valuable insights to client devices. The AP-related utilization data may allow client devices to identify the least congested APs, ensuring better QoS and more efficient use of network resources. Additionally, storing this data helps support seamless roaming, load balancing, and optimized P2P communication by guiding the client devices to the most suitable AP based on real-time network conditions. For example, the process 800 may be able to fetch the AP-related utilization data at any point in time to inform client devices to associate with APs that have lower channel utilization or fewer connected client devices, thus ensuring better QoS and reducing congestion.

In additional embodiments, the process 800 may determine whether a P2P service request is received (block 825). When a client device wants a P2P communication with another client device, the client device may want a low interference channel to communicate directly with the other client device. In order to do so, the client device may have to probe the AS to provide such a channel. This is done by the client device by transmitting a P2P service request to the AS. The P2P service request may be transmitted via an ANQP request message. If a P2P service request is not received, the process 800 may keep on monitoring for any client device transmitting such P2P service requests.

However, if a P2P service request is received from a client device, in numerous embodiments, the process 800 may select one or more BSSIDs (block 830). In still further embodiments, the process 800 may select the one or more BSSIDs from a pool of BSSIDs associated with a neighbor AP list based on the received P2P service request. The stored AP-utilization data may be analyzed to select the one or more BSSIDs.

In further embodiments, the process 800 may transmit a list of the selected one or more BSSIDs (block 840). The list of the selected one or more BSSIDs may be transmitted to the client device that had transmitted the P2P service request. The client device may be configured to select the most suitable BSSID from the list of the selected one or more BSSIDs and thereby determine an AP associated with the most suitable BSSID.

Although a specific embodiment for ANQP-based assistance for P2P exchange scheduling suitable for carrying out the various steps, processes, methods, and operations described herein is discussed with respect to FIG. 8, any of a variety of systems and/or processes may be utilized in accordance with embodiments of the disclosure. For example, the AP-related utilization data is received at periodic intervals. The elements depicted in FIG. 8 may also be interchangeable with other elements of FIGS. 1-7, 9, and 10 as required to realize a particularly desired embodiment.

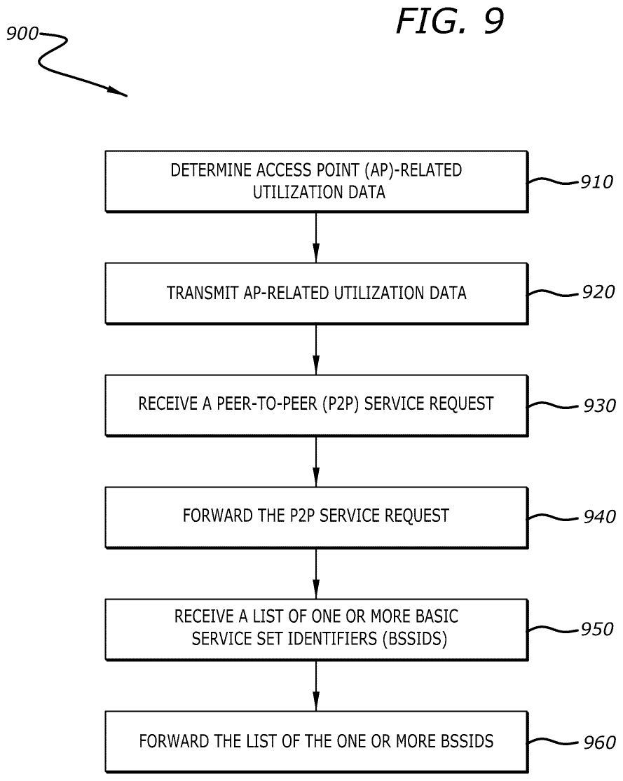

Referring to FIG. 9, a flowchart depicting a process for ANQP-based assistance for P2P exchange scheduling in accordance with various embodiments of the disclosure. The network may include a primary AP coupled to a plurality of neighboring APs. The process 900 may be performed by the primary AP. In many embodiments, the process 900 may determine AP-related utilization data (block 910). The AP-related utilization data may include channel utilization, a number of STAs associated with the primary AP, and P2P pair counts (e.g., a number of active P2P connections or links associated with a particular BSSID). The AP-related utilization data may further include available admission capacity.

In a variety of embodiments, the process 900 may transmit the AP-related utilization data (block 920). The process 900 may transmit the AP-related utilization data to an AS. The AS may be able to use the AP-related utilization data in selecting one or more BSSIDs for P2P communications.

In several embodiments, the process 900 may receive a P2P service request (block 930). The P2P service request may be received from a client device that wants to establish a P2P communication. The P2P service request may be received via an ANQP request message. In yet various embodiments, the ANQP request message may include a modular component of the ANQP protocol that may contain one or more sub-elements that specify different types of information being requested”. The client device may request the necessary information through the one or more sub-elements of the ANQP request message. For P2P service discovery, one such sub-element may be utilized to request information about the “best” available BSSID.

In still additional embodiments, the process 900 may forward the P2P service request (block 940). The process 900 may forward the P2P service request to the AS. In still further embodiments, the AS may select one or more BSSIDs from a pool of BSSIDs associated with a neighbor AP list based on the transmitted P2P service request.

In further embodiments, the process 900 may receive a list of the selected one or more BSSIDs (block 950). The list of the selected one or more BSSIDs may be received from the AS. The list may further include at least one of an indication of a P2P pair count or QBSS load data associated with at least one BSSID.

In numerous additional embodiments, the process may forward the list of the selected one or more BSSIDs (block 960). The process 900 may forward the list of the selected one or more BSSIDs to the client devices that had transmitted the P2P service request. The client device may be configured to select the most suitable BSSID from the list and thereby determine an AP for the P2P communication.

Although a specific embodiment for ANQP-based assistance for P2P exchange scheduling suitable for carrying out the various steps, processes, methods, and operations described herein is discussed with respect to FIG. 9, any of a variety of systems and/or processes may be utilized in accordance with embodiments of the disclosure. For example, the process 900 may be directly performed by the primary AP without transmitting the data to be analyzed to the AS. The elements depicted in FIG. 9 may also be interchangeable with other elements of FIGS. 1-8 and 10 as required to realize a particularly desired embodiment.

Referring to FIG. 10, a conceptual block diagram of a device 1000 suitable for configuration with a P2P exchange logic, in accordance with various embodiments of the disclosure is shown. The embodiment of the conceptual block diagram depicted in FIG. 10 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many nonlimiting examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a NIC 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022, P2P service data 1028, QBSS load data 1030, and BSSID data 1032 which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer executable instructions may be stored as application 1022 and transform the device 1000 by specifying how the processor(s) 1004 can transition between states, as described above. In some embodiments, the device 1000 has access to computer-readable storage media storing computer executable instructions which, when executed by the device 1000, perform the various processes described above with regard to FIGS. 1-10. In certain embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In many further embodiments, the device 1000 may include a P2P exchange logic 1024. The P2P exchange logic 1024 can be configured to perform one or more of the various steps, processes, operations, and/or other methods that are described above. Often, the P2P exchange logic 1024 can be a set of instructions stored within a non-volatile memory that, when executed by the processor(s)/controller(s) 1004 can carry out these steps, etc. In numerous embodiments, the P2P exchange logic 1024 may perform various operations related to P2P communication.

In an example scenario where the device 1000 corresponds to a client device, the P2P exchange logic 1024 may be configured to transmit a P2P service request and receive a list of one or more BSSIDs based on the transmitted P2P service request. In various embodiments, the P2P exchange logic 1024 may receive an indication of support for GAS or ANQP from an AP, and the P2P service request may be transmitted based on the indication of the support for GAS or ANQP. The P2P exchange logic 1024 may be further configured to select a BSSID based on the list and transmit a P2P scheduling request to an AP associated with the selected BSSID to establish a P2P communication. Further, the P2P exchange logic 1024 can opt out of associating with the AP associated with the selected BSSID or associate with the AP associated with the selected BSSID. In yet various embodiments, where the device 1000 supports MLO, the P2P exchange logic 1024 may associate with another AP different from the AP associated with the selected BSSID. In such a scenario, the P2P scheduling request can be transmitted to the AP associated with the selected BSSID via the other associated AP and a link between the other AP and the AP associated with the selected BSSID. In still various embodiments, the P2P exchange logic 1024 may receive P2P scheduling grant from the AP associated with the selected BSSID and perform a P2P exchange based on the received P2P scheduling grant.

In further example scenario where the device 1000 corresponds to a network device, such as an advertisement server or a WLC, the P2P exchange logic 1024 may be configured to receive a P2P service request and select one or more BSSIDs from a pool of BSSIDs associated with a neighbor AP list based on the received P2P service request and at least one criterion. The P2P exchange logic 1024 may be further configured to transmit a list of the selected one or more BSSIDs to a client device. Further, the P2P exchange logic 1024 may receive, from each AP of one or more APs on the neighbor AP list, an indication of at least one of a P2P pair count associated with the AP or QBSS load data associated with the AP and store the indication of at least one of the P2P pair count or the QBSS load data, for example, in the storage 1018.

In yet further example scenario where the device 1000 corresponds to a network device, such as an AP, the P2P exchange logic 1024 may be configured to transmit an indication of at least one of a P2P pair count associated with the device 1000 or QBSS load data associated with the device 1000 to an advertisement server. The P2P exchange logic 1024 may be further configured to forward a P2P service request and transmit a list of one or more BSSIDs as a response for the P2P service request.

In various embodiments, the storage 1018 can include the P2P service data 1028. The P2P service data 1028 refer to the information exchanged between client devices or STAs in a P2P network, often using Wi-Fi Direct or similar protocols. The P2P service data 1028 may include details about the services provided by each client device, such as file sharing, printing, or media streaming, and can be discovered through protocols that may include, for example, the GAS and ANQP. The P2P service data 1028 may enable client devices to discover, negotiate, and connect for specific services without needing to connect to a traditional infrastructure network.

In still more embodiments, the storage 1018 can include the QBSS load data 1030. The QBSS load data 1030 may provide information about the current load and capacity of a Wi-Fi network's BSS. The QBSS load data may further include metrics such as the number of active STAs, channel utilization, and available admission capacity. The QBSS load data 1030 may be utilized by client devices to assess the quality and performance of a network, helping them decide which AP or network segment to connect to for optimal performance.

In a number of embodiments, the storage 1018 can include BSSID data 1032. The BSSID data 1032 may refer to unique identifiers (for example, MAC addresses) of an AP or network segment within a Wi-Fi network. The BSSID data 1032 may help distinguish between different APs broadcasting the same SSID in a network, ensuring that client devices connect to the correct AP. The BSSID data 1032 may be used for efficient network management, roaming, and security, as the BSSID data 1032 may allow client devices to connect to the most suitable AP based on criteria like signal strength and load.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026.

The ML model(s) 1026 can be configured to generate inferences to make predictions or draw conclusions from data. An inference can be considered the output of a process of applying a model to new data. This can occur by learning from at least the P2P service data 1028, the QBSS load data 1030, and the BSSID data 1032, and utilize the learning to predict future outcomes. For example, the ML model(s) 1026 can be trained to select the best BSSID from the list of one or more BSSIDs. In an example scenario, the ML model(s) 1026 may be trained on historical selections of the BSSIDs for P2P scheduling and their associated criteria such as P2P pair count, QBSS load data, signal strength, or the like. Based on the training, the ML model(s) 1026 may automatically select the best BSSID from the list of one or more BSSIDs for P2P scheduling. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although a specific embodiment for a device suitable for configuration with a P2P exchange logic for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A client device, comprising:
a processor;
a network interface controller configured to provide access to a network; and
a memory communicatively coupled to the processor, wherein the memory comprises a peer-to-peer (P2P) exchange logic that is configured to:
transmit a P2P service request;
receive a list of one or more basic service set identifiers (BSSIDs) based on the transmitted P2P service request;
select a BSSID based on the list of one or more BSSIDs; and
transmit a P2P scheduling request to an access point (AP) associated with the selected BSSID.

2. The client device of claim 1, wherein the P2P service request is transmitted via an access network query protocol (ANQP) request message.

3. The client device of claim 2, wherein the P2P service request is transmitted to an advertisement server (AS) via a first AP, and the list of one or more BSSIDs is received from the AS via the first AP.

4. The client device of claim 3, wherein the P2P exchange logic is further configured to receive an indication of support for generic advertisement service (GAS) or ANQP from the first AP, and the P2P service request is transmitted based on the indication of the support for GAS or ANQP.

5. The client device of claim 1, wherein the selected BSSID is associated with a lowest signal strength at the client device.

6. The client device of claim 1, wherein the P2P exchange logic is further configured to opt out of associating with the AP associated with the selected BSSID.

7. The client device of claim 1, wherein the client device supports a multi-link operation (MLO), and the P2P exchange logic is further configured to associate with a first AP different from the AP associated with the selected BSSID.

8. The client device of claim 1, wherein the selected BSSID is on the list of one or more BSSIDs.

9. The client device of claim 1, wherein the client device includes a single radio.

10. The client device of claim 9, wherein the P2P exchange logic is further configured to associate with the AP associated with the selected BSSID.

11. The client device of claim 1, wherein the P2P exchange logic is further configured to associate with a first AP different from the AP associated with the selected BSSID, and the P2P scheduling request is transmitted to the AP associated with the selected BSSID via the first AP and a link between the first AP and the AP associated with the selected BSSID.

12. The client device of claim 1, wherein the list of one or more BSSIDs further comprises at least one of an indication of a P2P pair count or quality of service (QoS) basic service set (QBSS) load data associated with at least one of the one or more BSSIDs.

13. The client device of claim 1, wherein the P2P exchange logic is further configured to:
receive a P2P scheduling grant from the AP; and
perform a P2P exchange based on the received P2P scheduling grant.

14. The client device of claim 13, wherein the P2P scheduling grant is received in response to transmitting the P2P scheduling request.

15. A network device, comprising:
a processor;
a network interface controller configured to provide access to a network; and
a memory communicatively coupled to the processor, wherein the memory comprises a peer-to-peer (P2P) exchange logic that is configured to:
receive a P2P service request;
select one or more basic service set identifiers (BSSIDs) from a pool of BSSIDs associated with a neighbor access point (AP) list based on the received P2P service request and at least one criterion; and
transmit a list of the selected one or more BSSIDs.

16. The network device of claim 15, wherein the P2P service request is received from a client device via an AP, and the list of the selected one or more BSSIDs is transmitted to the client device via the AP.

17. The network device of claim 15, wherein based on the at least one criterion, each of the selected one or more BSSIDs is associated with a P2P pair count that is less than a first threshold or a channel utilization measure that is less than a second threshold.

18. The network device of claim 15, wherein the P2P exchange logic is further configured to:
receive, from each AP of one or more APs on the neighbor AP list, an indication of at least one of a P2P pair count associated with an AP or quality of service (QoS) basic service set (QBSS) load data associated with the AP; and
store the indication of at least one of the P2P pair count or the QBSS load data.

19. The network device of claim 15, wherein the network device corresponds to an advertisement server (AS) or a wireless local area network (LAN) controller (WLC).

20. A network device, comprising:
a processor;
a network interface controller configured to provide access to a network; and
a memory communicatively coupled to the processor, wherein the memory comprises a peer-to-peer (P2P) exchange logic that is configured to:
transmit an indication of at least one of a P2P pair count associated with the network device or quality of service (QoS) basic service set (QBSS) load data associated with the network device to an advertisement server;
forward a P2P service request; and
transmit a list of one or more basic service set identifiers (BSSIDs) as a response for the P2P service request.
